(19) United States
(12) Patent Application Publication
(10) Pub. No.: US 2020/0379298 A1
(43) Pub. Date: Dec. 3, 2020

(54) LIGHTING DEVICE AND LIQUID CRYSTAL DISPLAY APPARATUS

(71) Applicant: Panasonic Liquid Crystal Display Co., Ltd., Himeji-shi (JP)

(72) Inventors: Tomoharu NOTOSHI, Hyogo (JP); Masaki TSUBOKURA, Hyogo (JP)

(21) Appl. No.: 16/780,002

(22) Filed: Feb. 3, 2020

(30) Foreign Application Priority Data
May 29, 2019 (JP) 2019-100667

(51) Int. Cl. G02F 1/13357

(52) U.S. Cl. CPC G02F 1/133611; G02F 1/133603; G02F 1/133609; G02F 1/133606; G02F 1/133605

(57) ABSTRACT

A lighting device includes: a light source module having a plurality of light-emitting elements arranged two-dimensionally; a uniform luminance layer disposed on a light emission side of the light source module; and a first diffusion layer disposed between the light source module and the uniform luminance layer. The uniform luminance layer has a higher light transmittance as a distance from a point intersecting with an optical axis of each of the plurality of light-emitting elements increases.

### CROSS-REFERENCE TO RELATED APPLICATION

This application claims priority from Japanese application JP 2019-100667, filed on May 29, 2019. This Japanese application is incorporated herein by reference.

### TECHNICAL FIELD

The present disclosure relates to a lighting device and a liquid crystal display device.

### BACKGROUND

A liquid crystal display device equipped with a liquid crystal display panel can display an image with low power consumption and is thus used as a display for various uses such as a television, a monitor, and signage. The liquid crystal display device includes a liquid crystal display panel and a backlight disposed on the back surface side of the liquid crystal display panel.

In recent years, as the backlight for the liquid crystal display device, a light-emitting diode (LED) backlight made of LEDs has been used. The backlight is divided into an edge type and a direct type in accordance with an array structure of light-emitting elements such as LEDs. Of these types, the direct type LED backlight has a structure in which a plurality of light-emitting elements are arranged two-dimensionally. For example, Japanese Patent Application Laid-Open No. 2011-242488 discloses a liquid crystal display device including a direct type backlight made up of a plurality of two-dimensionally arranged LEDs.

### SUMMARY

In the backlight having the structure in which light-emitting elements such as LEDs are arranged two-dimensionally, a uniform luminance plate may be used as a uniform luminance layer in addition to a diffusion plate and a reflective plate in order to obtain surface emission with uniform luminance.

The uniform luminance plate has a configuration in which the light transmittance has an in-plane distribution corresponding to a plurality of light-emitting elements. For example, in a uniform luminance plate having a plurality of pores, the in-plane distribution is provided to the light transmittance by varying an opening area of each of the plurality of pores with respect to each of the plurality of light-emitting elements.

However, relative positions of the uniform luminance plate having such a configuration with respect to the plurality of light-emitting elements may deviate from design conditions during assembly due to warpage or the like caused by heat. As a result, the effect of making the luminance uniform by the uniform luminance plate is reduced, and luminance unevenness may occur.

The present disclosure provides a lighting device and a liquid crystal display device capable of preventing the occurrence of the luminance unevenness even when relative positions of a plurality of light-emitting elements and a uniform luminance plate deviate from design conditions.

A lighting device according to the present disclosure includes: a light source module having a plurality of light-emitting elements arranged two-dimensionally; a uniform luminance layer disposed on a light emission side of the light source module; and a first diffusion layer disposed between the light source module and the uniform luminance layer. The uniform luminance layer has a higher light transmittance as a distance from a point intersecting with an optical axis of each of the plurality of light-emitting elements increases.

A liquid crystal display apparatus according to the present disclosure includes: the lighting device disclosed above; and a liquid crystal display panel disposed on a light emission side of the lighting device.

### BRIEF DESCRIPTION OF THE DRAWINGS

FIG. 1 is a sectional view schematically illustrating a configuration of a liquid crystal display device according to a first exemplary embodiment;

FIG. 2 is a planar view illustrating a configuration of a uniform luminance layer used in the liquid crystal display device according to the first exemplary embodiment;

FIG. 3 is an enlarged planar view of the uniform luminance layer used in the liquid crystal display device according to the first exemplary embodiment;

FIG. 4 is a sectional view schematically illustrating a configuration of a liquid crystal display device according to a comparative example;

FIG. 5 is a sectional view schematically illustrating a configuration of a liquid crystal display device according to Modification 1 of the first exemplary embodiment;

FIG. 6 is a sectional view schematically illustrating a configuration of a liquid crystal display device according to Modification 2 of the first exemplary embodiment;

FIG. 7 is a sectional view schematically illustrating a configuration of a liquid crystal display device according to Modification 3 of the first exemplary embodiment;

FIG. 8 is a sectional view schematically illustrating a configuration of a liquid crystal display device according to Modification 4 of the first exemplary embodiment;

FIG. 9 is a sectional view schematically illustrating a configuration of a liquid crystal display device according to a second exemplary embodiment;

FIG. 10 is a sectional view schematically illustrating a configuration of a liquid crystal display device according to a modification of the second exemplary embodiment:

FIG. 11 is an enlarged planar view of a prism sheet used in the liquid crystal display device according to the modification of the second exemplary embodiment; and

FIG. 12 is a sectional view schematically illustrating a configuration of a liquid crystal display device according to a modification.

### DETAILED DESCRIPTION

Hereinafter, exemplary embodiments will be described with reference to the drawings. The following exemplary embodiments provide comprehensive or specific examples of the present disclosure. Numerical values, shapes, materials, components, disposition positions of the components, connection modes of the components, steps, and order of the steps that are illustrated in the following exemplary embodiments are examples, and therefore are not intended to limit the present disclosure. Among the components in the following exemplary embodiments, the components that are not recited in the independent claims indicating the broadest concept are described as an optional component.

The drawings are schematic diagrams, and not necessarily strictly illustrated. In the drawings, substantially the same configuration is designated by the same reference numerals, and overlapping description will be omitted or simplified.

### First Exemplary Embodiment

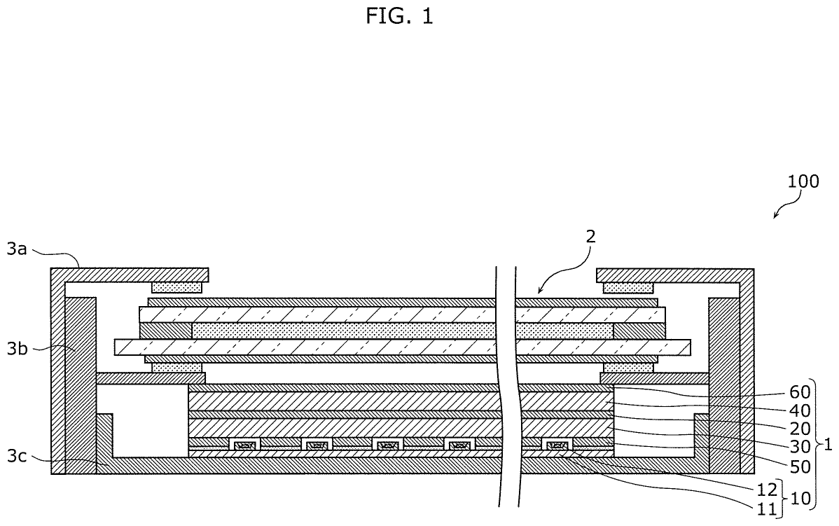

First, configurations of lighting device 1 and liquid crystal display device 100 according to the first exemplary embodiment will be described with reference to FIG. 1. FIG. 1 is a sectional view schematically illustrating the configuration of liquid crystal display device 100 according to a first exemplary embodiment.

As illustrated in FIG. 1, liquid crystal display device 100 includes lighting device 1 and liquid crystal display panel 2. Liquid crystal display device 100 further includes first frame 3a, second frame 3b, and third frame 3c to hold lighting device 1 and liquid crystal display panel 2.

Lighting device 1 is a backlight disposed on the back surface side of liquid crystal display panel 2 and irradiates liquid crystal display panel 2 with light. Specifically, lighting device 1 emits white light as illumination light.

Lighting device 1 is a surface emitting device that emits planar light with uniform luminance. In the present exemplary embodiment, lighting device 1 is a direct type LED backlight in which LED elements are two-dimensionally arranged so as to face liquid crystal display panel 2.

Lighting device 1 may be an LED backlight that supports local dimming for high dynamic range (HDR), for example, and emits high-luminance light. Hence it is possible to achieve liquid crystal display device 100 that can display a color image with high contrast and high image quality. A detailed configuration of lighting device 1 will be described later.

Liquid crystal display panel 2 is disposed on the light emission side of lighting device 1. Liquid crystal display panel 2 displays a color image or a monochrome image in an image display region. In the present exemplary embodiment, liquid crystal display panel 2 displays a color image. A driving method of liquid crystal display panel 2 is a horizontal electric field method such as an in-plane switching (IPS) method or a fringe field switching (FFS) method, but may be a vertical alignment (VA) method or a twisted nematic (TN) method.

Liquid crystal display panel 2 includes, for example, a liquid crystal cell having a pair of transparent substrates and a liquid crystal layer sealed between the pair of transparent substrates, and a pair of polarizing plates attached to the respective outer surfaces of the pair of transparent substrates in the liquid crystal cell. As the transparent substrate, a glass substrate, a transparent resin substrate, or the like can be used. A liquid crystal material of the liquid crystal layer can be appropriately selected in accordance with the driving method of liquid crystal display panel 2.

The transparent substrate on the lighting device 1 side (rear side) of the pair of transparent substrates is a thin film transistor (TFT) substrate having a TFT provided corresponding to each of a plurality of pixels arranged in a matrix The transparent substrate on the display surface side (front side) of the pair of transparent substrates is a counter substrate facing the TFT substrate. On the counter substrate, a color filter (CF) and a black matrix are formed.

On the TFT substrate, a plurality of video signal lines and a plurality of scanning signal lines are formed orthogonal to each other. The scanning signal line is provided for each horizontal column of pixels, for example, and is connected to a gate electrode of the TFT of each pixel. The video signal line is provided for each vertical column of pixels, for example, and is connected to a source electrode of the TFT of each pixel. In addition, a pixel electrode formed in each pixel is connected to a drain electrode of the TFT of each pixel.

The TFT of each pixel is on-off controlled in units of horizontal columns in accordance with a scanning signal that is applied to the gate electrode via the scanning signal line. When the TFT is turned on, a data voltage is supplied from the video signal line connected to the TFT to the pixel electrode corresponding to the TFT. An electric field is generated in the liquid crystal layer due to the difference between the data voltage supplied to the pixel electrode and a common voltage supplied to a common electrode. This electric field changes an alignment state of liquid crystal molecules in the liquid crystal layer in each pixel, and the transmittance for light incident on liquid crystal display panel 2 from lighting device 1 changes, so that a desired image is displayed in the image display region of liquid crystal display panel 2.

First frame 3a is a front frame disposed on the front side. In the present exemplary embodiment, first frame 3a is a metal frame having, for example, a rectangular frame shape in a planar view and an L-shaped cross section, and is made of a metal material having high rigidity such as a steel plate or an aluminum plate. In the present exemplary embodiment, first frame 3a includes a bezel portion that covers a periphery of liquid crystal display panel 2, and a side wall portion located lateral to liquid crystal display panel 2 and lighting device 1. The bezel portion protrudes in a flange shape from the upper end of the side wall portion, and is formed in a frame shape so as to cover the entire outer peripheral end of the surface of liquid crystal display panel 2.

Second frame 3b is a middle frame disposed between first frame 3a and third frame 3c. Second frame 3b supports liquid crystal display panel 2 from the lighting device 1 side. As second frame 3b, a mold frame formed by molding a synthetic resin can be used. However, the material of second frame 3b is not limited to a resin material but may be a metal material. In the present exemplary embodiment, second frame 3b has a side wall portion and a protruding portion that protrudes inward from the side wall portion. The outer peripheral end of liquid crystal display panel 2 is located between the protruding portion of second frame 3b and the bezel portion of first frame 3a.

Third frame 3c is a rear frame disposed on the back surface side. In the present exemplary embodiment, third frame 3c is a metal housing formed in a concave shape as a whole, and is made of a metal material having high rigidity such as a steel plate or an aluminum plate. Third frame 3c is a base that supports light source module 10 of lighting device 1. Third frame 3c may be one of the members constituting lighting device 1.

Next, a detailed configuration of lighting device 1 in the present exemplary embodiment will be described with reference to FIG. 1.

Lighting device 1 includes light source module 10, uniform luminance layer 20, first diffusion layer 30, second diffusion layer 40, reflective layer 50, and optical sheet 60.

In lighting device 1, light source module 10, reflective layer 50, first diffusion layer 30, uniform luminance layer 20, second diffusion layer 40, and optical sheet 60 are laminated in this order. That is, reflective layer 50 is laminated on light source module 10, first diffusion layer 30 is laminated on reflective layer 50, uniform luminance layer 20 is laminated on first diffusion layer 30, second diffusion layer 40 is laminated on uniform luminance layer 20, and optical sheet 60 is laminated on second diffusion layer 40.

Light source module 10 is a light source unit that emits light of a predetermined color (wavelength). In the present exemplary embodiment, light source module 10 emits white light. Light source module 10 is an LED module made up of LEDs.

Light source module 10 includes substrate 11 and a plurality of light-emitting elements 12 arranged on substrate 11.

Substrate 11 is disposed above third frame 3c. Specifically, substrate 11 is placed on third frame 3c.

Substrate 11 is a mounting substrate for mounting light-emitting element 12. Substrate 11 is a wiring substrate on which metal wiring having a predetermined shape is formed. As a base material of substrate 11, a resin substrate, a ceramic substrate, a metal substrate, or the like can be used. In the present exemplary embodiment, a glass epoxy substrate (CEM-3, FR-4, etc.) made of glass fiber and epoxy resin is used as the base material of substrate 11.

The plurality of light-emitting elements 12 are two-dimensionally arranged on substrate 11. Specifically, the plurality of light-emitting elements 12 are arranged in a matrix at a predetermined pitch along a horizontal column (row direction) and a vertical column (column direction) of the pixels of liquid crystal display panel 2. In the present exemplary embodiment, the plurality of light-emitting elements 12 are mounted at substantially equal intervals in the row direction and the column direction.

Each light-emitting element 12 is an LED light source made up of LEDs. In the present exemplary embodiment, each of the plurality of light-emitting elements 12 is a white LED light source that emits white light. Light-emitting element 12 is, for example, an LED element of an individually packaged surface mount device (SMD) type, and includes a container (package) made of resin or the like, an LED chip (bare chip) disposed in the container, and a sealing member for sealing the LED chip. Specifically, light-emitting element 12 is an SMD type white LED element that emits white light. In this case, for example, a blue LED chip that emits blue light when energized is used as the LED chip, and a silicone resin containing a yellow phosphor (phosphor-containing resin) is used as a sealing member filled in the container.

Light source module 10 emits light with power supplied from a power supply unit (not illustrated). The power supply unit has, for example, a power supply (power supply circuit) made up of a circuit board on which a plurality of circuit components are mounted. The power supply converts power received by the power supply unit into predetermined power and supplies light source module 10 (light-emitting element 12) with power. Thereby, light source module 10 (light-emitting element 12) emits light.

Uniform luminance layer 20 is a uniform luminance layer and is an optical member for making uniform the luminance of light emitted from lighting device 1. Specifically, uniform luminance layer 20 is a flat uniform luminance plate. By using uniform luminance layer 20, the light emitted from lighting device 1 can be made into planar light with high luminance uniformity. That is, uniform luminance layer 20 is a flutter plate for obtaining surface emission with uniform luminance.

Uniform luminance layer 20 has a configuration in which the light transmittance has an in-plane distribution corresponding to the plurality of light-emitting elements 12. In the present exemplary embodiment, the light transmittance increases as the distance from the point intersecting with an optical axis of each of the plurality of light-emitting elements 12 increases.

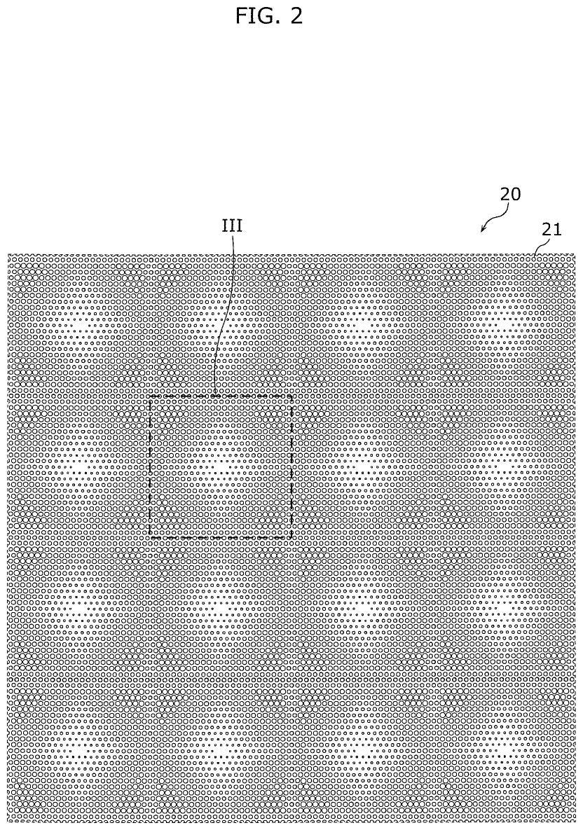

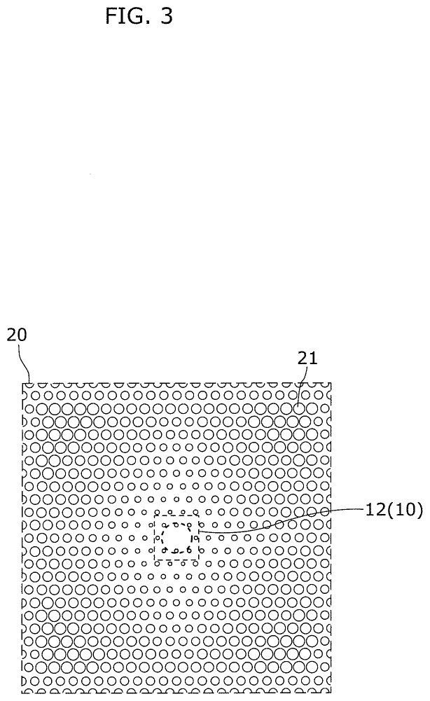

Specifically, as illustrated in FIGS. 2 and 3, uniform luminance layer 20 is provided with a plurality of pores 21, through each of which light emitted from each of the plurality of light-emitting elements 12 passes respectively. FIG. 2 is a planar view illustrating a configuration of uniform luminance layer 20 used in liquid crystal display device 100 according to the first exemplary embodiment. FIG. 3 is an enlarged planar view of uniform luminance layer 20 in region III surrounded by a broken line in FIG. 2.

Each of the plurality of pores 21 is a through-hole penetrating uniform luminance layer 20. Each of the plurality of pores 21 further divides the light emitted from each of the plurality of light-emitting elements 12 in light source module 10. That is, the light from the plurality of light-emitting elements 12 can be further divided into an infinite number of point light sources. As illustrated in FIGS. 2 and 3, in the present exemplary embodiment, a planar-view shape of each of the plurality of pores 21 is circular, but is not limited to this.

As illustrated in FIG. 3, the plurality of pores 21 in uniform luminance layer 20 are formed in a pattern such that the light transmittance increases as the distance from the point intersecting with the optical axis of each of the plurality of light-emitting elements 12 increases. Specifically, an opening area of each of the plurality of pores 21 increases as the distance from the point intersecting with the optical axis of each of the plurality of light-emitting elements 12 increases. In the present exemplary embodiment, since the planar-view shape of each of the plurality of pores 21 is circular, the light transmittance is increased by increasing a diameter of each of the plurality of pores 21 as the distance from the point intersecting with the optical axis of each of the plurality of light-emitting elements 12 increases.

Light emitted from light-emitting element 12 of light source module 10 passes through each of the plurality of pores 21 provided in uniform luminance layer 20. Specifically, not only the light emitted from light-emitting element 12 directly enters and passes through a plurality of pores 21, but also the light emitted from light-emitting element 12 and reflected by reflective layer 50 passes through a plurality of pores 21.

In addition, uniform luminance layer 20 has light reflectivity at least on a surface facing light source module 10. Therefore, among the light having been emitted from light-emitting element 12 and reached uniform luminance layer 20, light not passing through the pore 21 is reflected by the surface of uniform luminance layer 20 on light source module 10 side. In the present exemplary embodiment, uniform luminance layer 20 has light reflectivity on both the surface on light source module 10 side (the surface on first diffusion layer 30 side) and the surface on second diffusion layer 40 side. That is, the entire surface of uniform luminance layer 20 has light reflectivity. Specifically, the surface of uniform luminance layer 20 is white. As an example, uniform luminance layer 20 is made of a white resin material such as polyethylene terephthalate.

Uniform luminance layer 20 configured as described above is disposed on the light emission side of light source module 10. Specifically, uniform luminance layer 20 is supported by first diffusion layer 30 disposed on the light emission side of light source module 10.

In the present exemplary embodiment, uniform luminance layer 20 is disposed between first diffusion layer 30 and second diffusion layer 40, and first diffusion layer 30, uniform luminance layer 20 and second diffusion layer 40 are laminated in this order. Specifically, uniform luminance layer 20 is sandwiched between first diffusion layer 30 and second diffusion layer 40. There may be no air layer between uniform luminance layer 20 and first diffusion layer 30 and between uniform luminance layer 20 and second diffusion layer 40.

First diffusion layer 30 is disposed between light source module 10 and uniform luminance layer 20. That is, first diffusion layer 30 is disposed on light source module 10 side of uniform luminance layer 20. In the present exemplary embodiment, first diffusion layer 30 is supported by reflective layer 50 disposed on light source module 10 side of uniform luminance layer 20. Specifically, first diffusion layer 30 is sandwiched between uniform luminance layer 20 and reflective layer 50, and no air layer may exist between uniform luminance layer 20 and reflective layer 50.

Second diffusion layer 40 is disposed on the opposite side of uniform luminance layer 20 from first diffusion layer 30 side. Specifically, second diffusion layer 40 is disposed between uniform luminance layer 20 and optical sheet 60. In the present exemplary embodiment, second diffusion layer 40 is supported by uniform luminance layer 20.

First diffusion layer 30 and second diffusion layer 40 are optical members having an action of diffusing (scattering) incident light. First diffusion layer 30 and second diffusion layer 40 are flat diffusion plates such as a sheet-like diffusion sheet or a film-like diffusion film.

For example, each of first diffusion layer 30 and second diffusion layer 40 includes a base material layer to be a transparent resin material such as polyethylene terephthalate (PET), and a plurality of light-diffusing fine particles dispersed in the base material layer. The light-diffusing fine particles may diffuse light by using the refractive index difference between the light-diffusing fine particles and the base material layer, or may diffuse light by scattering and reflecting light with the light-diffusing fine particles. The light-diffusing fine particles in the case of diffusing light by the refractive index difference are, for example, light-diffusing fine particles such as translucent fine particles made of a resin material or the like or air particles (bubbles). The light-diffusing fine particles in the case of diffusing light by scattering reflection are, for example, fillers or white fine particles made of an inorganic material, metal fine particles, or the like. First diffusion layer 30 and second diffusion layer 40 may have a diffusing action by formation of a projection and recess structure on the surface.

The diffusivity of first diffusion layer 30 maybe smaller than the diffusivity of second diffusion layer 40. Specifically, a haze value of first diffusion layer 30 may be smaller than a haze value of second diffusion layer 40.

Reflective layer 50 is a reflective member having a reflective surface. Reflective layer 50 is a flat reflective plate, for example. As an example, reflective layer 50 is a reflective sheet made of a white resin material. Reflective layer 50 is not limited to a resin sheet made of a resin material, but may be a metal plate made of a metal material such as a steel plate or an aluminum plate. In this case, a surface of reflective layer 50 that is a metal plate is preferably white-coated. The shape of reflective layer 50 is not limited to a flat plate shape but may be a box-shaped housing having a flat bottom portion.

Reflective layer 50 is disposed on light source module 10 side of uniform luminance layer 20. Reflective layer 50 is disposed between third frame 3c and first diffusion layer 30. In the present exemplary embodiment, reflective layer 50 is disposed between substrate 11 of light source module 10 and first diffusion layer 30. Specifically, reflective layer 50 is placed on substrate 11 of light source module 10 and supported by substrate 11. Reflective layer 50 is attached to substrate 11 with an adhesive layer such as an adhesive or a double-sided tape, for example.

Reflective layer 50 has a reflective surface that reflects light emitted from each of the plurality of light-emitting elements 12 of light source module 10. Specifically, reflective layer 50 reflects the light emitted from light-emitting element 12 and diffused by first diffusion layer 30, and reflects the light emitted from light-emitting element 12, diffused by first diffusion layer 30, and reflected by uniform luminance layer 20.

In reflective layer 50, a plurality of rectangular openings corresponding respectively to the plurality of light-emitting elements 12 are formed. Each of the plurality of light-emitting elements 12 is disposed in a corresponding one of the openings of reflective layer 50. Specifically, one light-emitting element 12 is disposed in one opening of reflective layer 50.

In the present exemplary embodiment, a thickness of reflective layer 50 is larger than a height of light-emitting element 12. Therefore, the reflective surface of reflective layer 50 is located closer to uniform luminance layer 20 than light-emitting surfaces of the plurality of light-emitting elements 12.

Optical sheet 60 is an optical member that imparts an optical action to the light emitted from light source module 10. In the present exemplary embodiment, optical sheet 60 is disposed on the opposite side of second diffusion layer 40 from light source module 10 side. Specifically, optical sheet 60 is disposed between second diffusion layer 40 and liquid crystal display panel 2. Therefore, optical sheet 60 imparts an optical action to the light transmitted through second diffusion layer 40.

Optical sheet 60 is, for example, a prism sheet, a diffusion sheet, or a polarizing sheet. Optical sheet 60 is not limited to one but may be made up of a plurality of sheets selected from a prism sheet, a diffusion sheet, and a polarizing sheet. The polarizing sheet is, for example, a reflective polarizing film, and is a dual brightness enhancement film (DBEF) manufactured by the 3M Company.

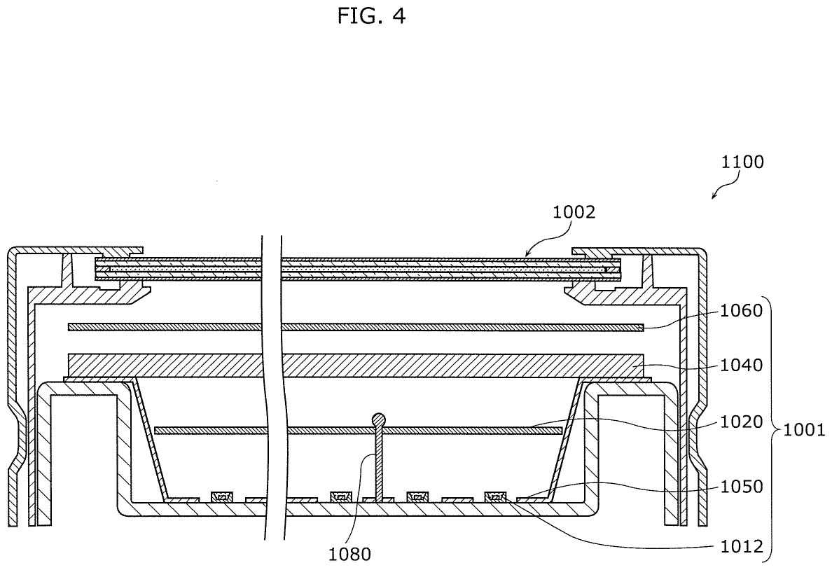

Next, actions of lighting device 1 and liquid crystal display device 100 according to the present exemplary embodiment will be described in comparison with lighting device 1001 and liquid crystal display device 1100 of the comparative example illustrated in FIG. 4.

Liquid crystal display device 1100 illustrated in FIG. 4 includes lighting device 1001 and liquid crystal display panel 1002. Lighting device 1001 includes light-emitting elements 1012 arranged in a two-dimensional manner, reflective plate 1050 that reflects light from light-emitting element 1012, diffusion plate 1040 disposed on the light emission side of the plurality of light-emitting elements 1012, uniform luminance plate 1020 disposed between 1040 and the plurality of light-emitting elements 1012, and optical sheet 1060 disposed between diffusion plate 1040 and liquid crystal display panel 1002.

Uniform luminance plate 1020 has a configuration in which the light transmittance has an in-plane distribution corresponding to the plurality of light-emitting elements 1012. Specifically, uniform luminance plate 1020 is, for example, a flutter plate having a plurality of pores, and the light transmittance has an in-plane distribution by varying an opening area of each of the plurality of pores with respect to each of the plurality of light-emitting elements 1012. Uniform luminance plate 1020 is white and has a reflection function.

In lighting device 1001 configured in this manner, uniform luminance plate 1020 having the plurality of pores can divide the plurality of light-emitting elements 1012 into innumerable point light sources equal to or more than the number of the plurality of light-emitting elements 1012, and reflect the light of each of the plurality of light-emitting elements 1012. As a result, in each of air layers with the plurality of light-emitting elements 1012, uniform luminance plate 1020, and diffusion plate 1040, the light of each of the plurality of light-emitting elements 1012 can be diffusely reflected and mixed, so that the luminance can be made uniform over the entire area of diffusion plate 1040. As described above, by disposing uniform luminance plate 1020 between the plurality of light-emitting elements 1012 and diffusion plate 1040, planar light with high luminance uniformity can be extracted from diffusion plate 1040.

Such uniform luminance plate 1020 has a configuration in which the light transmittance has an in-plane distribution with respect to each of the plurality of light-emitting elements 1012, and therefore, uniform luminance plate 1020 and the plurality of light-emitting elements 1012 need to be disposed such that relative positions of uniform luminance plate 1020 and the plurality of light-emitting elements 1012 meet design conditions.

However, when uniform luminance plate 1020 is disposed facing the plurality of light-emitting elements 1012 during assembly of lighting device 1001, or due to warpage of the like of uniform luminance plate 1020 caused by heat of the light-emitting elements 1012 or the like during use of liquid crystal display device 1100, the relative positions of uniform luminance plate 1020 and the plurality of light-emitting elements 1012 may deviate from the design conditions. As a result, the effect of making the uniform luminance in uniform luminance plate 1020 is reduced, and luminance unevenness may occur instead.

Then, as in lighting device 1001 illustrated in FIG. 4, it is conceivable to fix uniform luminance plate 1020 with pin 1080 such as a pin mold, but a pinhead of pin 1080 protrudes from the uniform luminance plate 1020, and the luminance unevenness may occur due to a shadow of the pinhead.

On the other hand, in lighting device 1 and liquid crystal display device 100 according to the present exemplary embodiment, first diffusion layer 30 is disposed between light source module 10 and uniform luminance layer 20.

With this configuration, the light emitted from each of the plurality of light-emitting elements 12 is diffused by first diffusion layer 30 and is then incident on uniform luminance layer 20. That is, the light of each of the plurality of light-emitting elements 12 can be blurred by first diffusion layer 30, and the light of light-emitting element 12 blurred by first diffusion layer 30 is incident on uniform luminance layer 20. Thereby, even when the relative positions of the plurality of light-emitting elements 12 and uniform luminance layer 20 slightly deviate from the design conditions, it is possible to prevent the occurrence of the luminance unevenness and maintain the ability of uniform luminance layer 20 making the luminance uniform. Further, it is possible to increase an allowable range of positional deviation during assembly of the plurality of light-emitting elements 12 and uniform luminance layer 20.

Lighting device 1 according to the present exemplary embodiment includes reflective layer 50 disposed on light source module 10 side of uniform luminance layer 20. Uniform luminance layer 20 has light reflectivity at least on the surface on the light source module 10 side, and uniform luminance layer 20 is provided with a plurality of pores 21, through each of which light emitted from each of the plurality of light-emitting elements 12 passes. The plurality of pores 21 are configured such that the light transmittance increases as the distance from the point intersecting with the optical axis of each of the plurality of light-emitting elements 12 increases.

With this configuration, the light of each of the plurality of light-emitting elements 12 blurred by first diffusion layer 30 is transmitted through the pore 21 of uniform luminance layer 20, is divided innumerably more than the number of the plurality of light-emitting elements 12, and is incident on light enters second diffusion layer 40 and reflected by uniform luminance layer 20. The light reflected by uniform luminance layer 20 is diffused by first diffusion layer 30, reflected by reflective layer 50, diffused again by first diffusion layer 30, and reaches uniform luminance layer 20. The light is then transmitted through each of the pores 21 of uniform luminance layer 20 and reflected by uniform luminance layer 20.

As a result, the light emitted from each of the plurality of light-emitting elements 12 is diffused by first diffusion layer 30 between uniform luminance layer 20 and reflective layer 50 and repeatedly reflected between uniform luminance layer 20 and reflective layer 50 to be mixed, and is transmitted through each of the pores 21 of uniform luminance layer 20. Hence it is possible to easily obtain planar light with high luminance uniformity.

Specifically, in lighting device 1 according to the present exemplary embodiment, since second diffusion layer 40 is disposed on the opposite side of uniform luminance layer 20 to first diffusion layer 30 side, innumerable light mixed between uniform luminance layer 20 and the reflective layer 50 and transmitted through each of the pores 21 of uniform luminance layer 20 is further diffused by second diffusion layer 40. Thereby, planar light having a high luminance uniformity can be extracted from second diffusion layer 40.

In lighting device 1 according to the present exemplary embodiment, the reflective surface of reflective layer 50 is located closer to uniform luminance layer 20 than the light-emitting surfaces of the plurality of light-emitting elements 12, and first diffusion layer 30 is supported by reflective layer 50.

With this configuration, since first diffusion layer 30 on which uniform luminance layer 20 is laminated is supported by reflective layer 50, even when heat of light-emitting element 12 is applied to uniform luminance layer 20, uniform luminance layer 20 can be prevented from warping. Specifically, it is possible to prevent uniform luminance layer 20 from warping so as to drop toward light-emitting element 12 due to the heat of light-emitting element 12. Therefore, the luminance unevenness due to the warpage of uniform luminance layer 20 can be prevented. Further, since uniform luminance layer 20 can be fixed without using a pin such as a pin mold, it is possible to prevent a shadow from being generated by the pinhead.

Further, in lighting device 1 according to the present exemplary embodiment, light source module 10, reflective layer 50, first diffusion layer 30, uniform luminance layer 20, and second diffusion layer 40 are laminated with no air layer interposed between each of the module and layers.

With this configuration, thin lighting device 1 can be achieved.

### Modification 1 of First Exemplary Embodiment

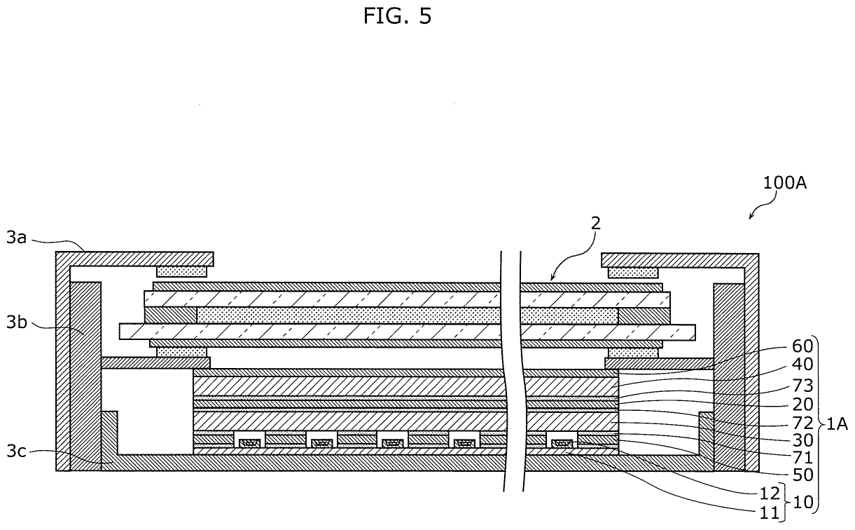

Next, lighting device 1A and liquid crystal display device 100A according to Modification 1 of the first exemplary embodiment will be described with reference to FIG. 5. FIG. 5 is a sectional view schematically illustrating a configuration of liquid crystal display device 100A according to Modification 1 of the first exemplary embodiment.

Lighting device 1A used in liquid crystal display device 100A according to the present modification has a configuration in which reflective layer 50, first diffusion layer 30, uniform luminance layer 20, and second diffusion layer 40 in lighting device 1 according to the first exemplary embodiment are bonded together.

Specifically, reflective layer 50 and first diffusion layer 30 are bonded together by first adhesive layer 71. Further, first diffusion layer 30 and uniform luminance layer 20 are bonded together by second adhesive layer 72, and uniform luminance layer 20 and second diffusion layer 40 are bonded together by third adhesive layer 73.

As first adhesive layer 71, second adhesive layer 72, and third adhesive layer 73, an optical adhesive sheet (OCA; Optical Clear Adhesive), an optical adhesive (OCR; Optical Clear Resin), a double-sided tape, or the like can be used. In the present exemplary embodiment, OCA is used as first adhesive layer 71, second adhesive layer 72, and third adhesive layer 73.

As described above, in lighting device 1A and liquid crystal display device 100A according to the present modification, as in lighting device 1 and liquid crystal display device 100 according to the first exemplary embodiment, first diffusion layer 30 is disposed between light source module 10 and uniform luminance layer 20.

With this configuration, even when the relative positions of the plurality of light-emitting elements 12 and uniform luminance layer 20 slightly deviate from the design conditions, it is possible to prevent the occurrence of the luminance unevenness and maintain the effect of luminance uniform layer 20 making the luminance uniform.

In addition, lighting device 1A and liquid crystal display device 100A according to the present modification have a configuration in which reflective layer 50, first diffusion layer 30, uniform luminance layer 20, and second diffusion layer 40 are bonded together.

With this configuration, it is possible to fix horizontal and thickness positions of reflective layer 50, first diffusion layer 30, uniform luminance layer 20, and second diffusion layer 40. That is, it is possible to determine the positions in the three-axis directions of the X direction, the Y direction, and the Z-axis direction in the XYZ three-axis orthogonal coordinate system. This can eliminate positional deviation in three-axis directions for reflective layer 50, first diffusion layer 30, uniform luminance layer 20, second diffusion layer 40, and the plurality of light-emitting elements 12, thereby preventing the luminance unevenness due to the positional deviation.

### Modification 2 of the First Exemplary Embodiment

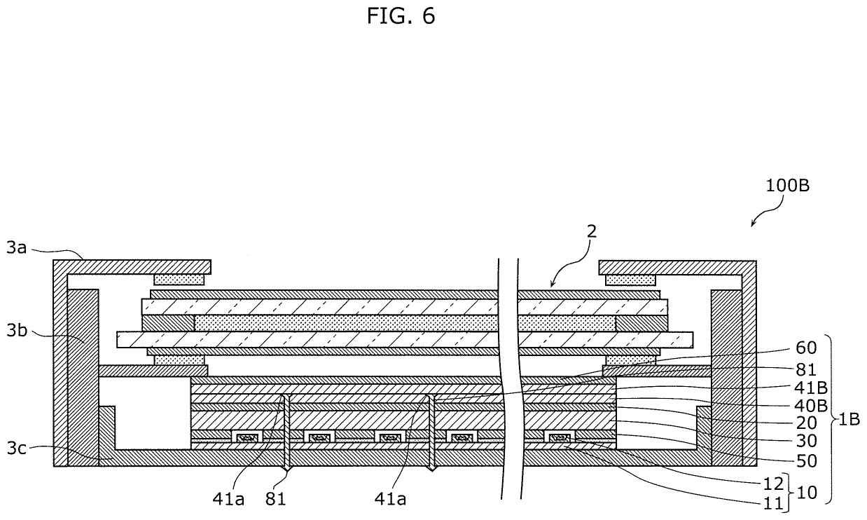

Next, lighting device 1B and liquid crystal display device 100B according to Modification 2 of the first exemplary embodiment will be described with reference to FIG. 6. FIG. 6 is a sectional view schematically illustrating a configuration of liquid crystal display device 100B according to Modification 2 of the first exemplary embodiment.

Lighting device 1B in the present modification differs from the above lighting device 1A illustrated in FIG. 5 in a method for fixing second diffusion layer 40B, uniform luminance layer 20, first diffusion layer 30, and reflective layer 50.

As illustrated in FIG. 6, in lighting device 1B according to the present modification, second diffusion layer 40B, uniform luminance layer 20, first diffusion layer 30, reflective layer 50, and third frame 3c (base) are fixed with translucent rivet pin 81 that penetrates second diffusion layer 40B, uniform luminance layer 20, first diffusion layer 30, reflective layer 50, and third frame 3c. In the present modification, reflective layer 50 is placed on substrate 11 of light source module 10, and substrate 11 is located between reflective layer 50 and third frame 3c. Thus, rivet pin 81 penetrates second diffusion layer 40B, uniform luminance layer 20, first diffusion layer 30, reflective layer 50, substrate 11, and third frame 3c.

With this configuration, it is possible to fix horizontal and thickness positions of second diffusion layer 40B, uniform luminance layer 20, first diffusion layer 30, reflective layer 50, substrate 11, and third frame 3c. That is, it is possible to determine the positions in the three-axis directions of the X direction, the Y direction, and the Z-axis direction in the XYZ three-axis orthogonal coordinate system. This can eliminate positional deviation in the three-axis directions for second diffusion layer 40B, uniform luminance layer 20, first diffusion layer 30, reflective layer 50, substrate 11, third frame 3c, and the plurality of light-emitting elements 12, thereby preventing the occurrence of the luminance unevenness due to the positional deviation. Second diffusion layer 40B, uniform luminance layer 20, first diffusion layer 30, reflective layer 50, substrate 11, and third frame 3c are fixed by a plurality of rivet pins 81.

Further, in the present modification, since the translucent rivet pin 81 is used, the occurrence of the luminance unevenness due to a shadow of rivet pin 81 can be prevented. As rivet pin 81, a resin pin made of a transparent resin material such as polycarbonate or acrylic is used preferably. In this case, as the transparent resin material of rivet pin 81, a material having a small refractive index difference from a transparent resin material constituting first diffusion layer 30 and second diffusion layer 40B is used preferably. Therefore, the transparent resin material of rivet pin 81 is preferably the same as the transparent resin material constituting first diffusion layer 30 and second diffusion layer 40B.

Further, as in the above lighting device 1A illustrated in FIG. 5, when second diffusion layer 40, uniform luminance layer 20, first diffusion layer 30, and reflective layer 50 are bonded together by using an adhesive such as OCA, the bonding needs to be performed so that the number of times of bonding is not increased and no positional deviation occurs. There is thus a possibility that an assembling cost of lighting device 1A may increase. In contrast, in lighting device 1B according to the present modification, second diffusion layer 40B, uniform luminance layer 20, first diffusion layer 30, reflective layer 50, substrate 11 and third frame 3c are fixed with rivet pin 81 without using OCA. Thereby, lighting device 1B can be assembled at a low cost.

Further, lighting device 1B in the present modification has a configuration in which second diffusion layer 40 in the first exemplary embodiment is divided into a plurality of parts. Specifically, in the present modification, second diffusion layer 40 in the first exemplary embodiment is divided into second diffusion layer 40B and third diffusion layer 41B. Lighting device 1B includes third diffusion layer 41B disposed on the opposite side of second diffusion layer 40B from the uniform luminance layer 20 side. Specifically, third diffusion layer 41B is laminated on second diffusion layer 40B.

In the present modification, recess 41a that stores a pinhead of rivet pin 81 is provided on a surface of second diffusion layer 40B on third diffusion layer 41B side. Rivet pin 81 penetrates second diffusion layer 40B, uniform luminance layer 20, first diffusion layer 30, reflective layer 50, substrate 11, and third frame 3c so that the pinhead is stored in recess 41a of second diffusion layer 40B. That is, rivet pin 81 penetrates second diffusion layer 40B and does not penetrate third diffusion layer 41B.

With this configuration, it is possible to prevent the occurrence of the luminance unevenness due to the pinhead of rivet pin 81 being shaded. In particular, even if the pinhead of rivet pin 81 is transparent, when the pinhead of rivet pin 81 protrudes from third diffusion layer 41B, there is a concern about a shadow due to the pinhead. However, by storing the pinhead of rivet pin 81 in recess 41a of second diffusion layer 40B, it is possible to prevent a shadow from occurring due to the pinhead of rivet pin 81.

Moreover, when the pinhead of rivet pin 81 protrudes from third diffusion layer 41B, the pinhead of rivet pin 81 and optical sheet 60 may interfere with each other, but by storing the pinhead of rivet pin 81 in recess 41a of second diffusion layer 40B, it is possible to avoid interference between the pinhead of rivet pin 81 and optical sheet 60.

In addition, in lighting device 1B and liquid crystal display device 100B according to the present modification, first diffusion layer 30 is disposed between light source module 10 and uniform luminance layer 20 as in lighting device 1 and liquid crystal display device 100 according to the first exemplary embodiment.

With this configuration, even when the relative positions of the plurality of light-emitting elements 12 and uniform luminance layer 20 slightly deviate from the design conditions, it is possible to prevent the occurrence of the luminance unevenness and maintain the effect of luminance uniform layer 20 making the luminance uniform.

### Modification 3 of the First Exemplary Embodiment

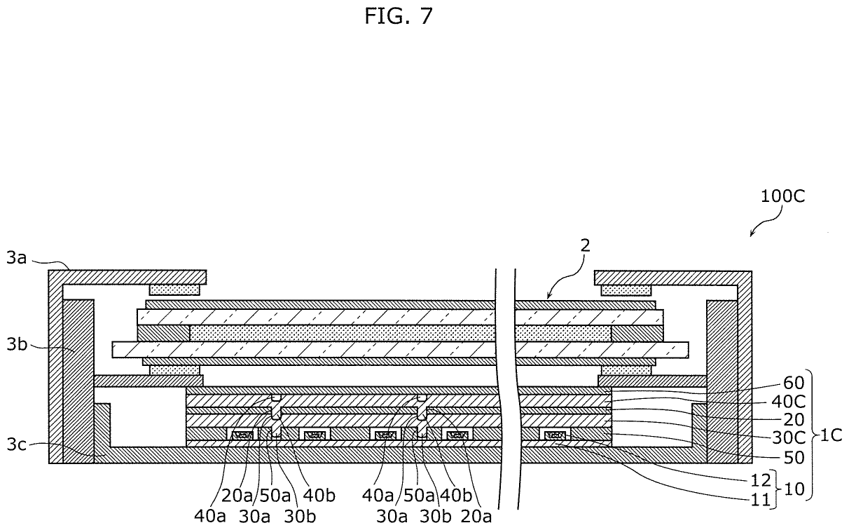

Next, lighting device 1C and liquid crystal display device 100C according to Modification 3 of the first exemplary embodiment will be described with reference to FIG. 7. FIG. 7 is a sectional view schematically illustrating a configuration of liquid crystal display device 100C according to Modification 3 of the first exemplary embodiment.

Lighting device 1C in the present modification differs from the above lighting devices 1A and 1B illustrated in FIGS. 5 and 6 in a method for fixing second diffusion layer 40C, uniform luminance layer 20, first diffusion layer 30C, and reflective layer 50.

As illustrated in FIG. 7, in lighting device 1C according to the present modification, second diffusion layer 40C, uniform luminance layer 20, first diffusion layer 30C, and reflective layer 50 are fixed to each other by a fitting structure using recesses and protrusions.

Specifically, first diffusion layer 30C has recess 30a provided at a position facing protrusion 40b of second diffusion layer 40C on one surface which is a surface facing the uniform luminance layer 20 side, and protrusion 30b provided at a position facing recess 30a on the other surface facing away from the surface. A plurality of recesses 30a and protrusions 30b are provided in first diffusion layer 30C. An opening shape of recess 30a and a planar-view shape of protrusion 30b are circular as an example but are not limited to this.

Similarly, second diffusion layer 40C has recess 40a provided on the other surface facing away from one surface which is the surface facing the uniform luminance layer 20 side, and protrusion 40b provided at a position facing recess 40a on the surface facing the luminance uniform layer 20 side. A plurality of the recesses 40a and the protrusions 40b are provided in second diffusion layer 40C. An opening shape of recess 40a and a planar-view shape of protrusion 40b are circular as an example but are not limited to this.

In the present exemplary embodiment, first diffusion layer 30C and second diffusion layer 40C have the same shape. Thus, recess 30a of first diffusion layer 30C and protrusion 40b of second diffusion layer 40C can be fitted together by press-fitting. Further, protrusion 30b of first diffusion layer 30C and recess 40a of second diffusion layer 40C can be fitted together by press-fitting. That is, first diffusion layer 30C and second diffusion layer 40C can be fixed by fitting the projection and recess structure to each other. First diffusion layer 30C and second diffusion layer 40C can be manufactured by injection molding.

Uniform luminance layer 20 has through-hole 20a. Protrusion 40b of second diffusion layer 40C penetrates through-hole 20a. Specifically, protrusion 40b of second diffusion layer 40C is inserted into through-hole 20a by press-fitting. A height of protrusion 40b of second diffusion layer 40C is larger than a thickness of uniform luminance layer 20. Therefore, protrusion 40b of second diffusion layer 40C penetrates through-hole 20a.

In the present modification, protrusion 40b of second diffusion layer 40C penetrates through-hole 20a of uniform luminance layer 20 and is fitted into recess 30a of first diffusion layer 30C.

With this configuration, uniform luminance layer 20 can be sandwiched and fixed between first diffusion layer 30C and second diffusion layer 40C. Thereby, it is possible to fix horizontal and thickness positions of second diffusion layer 40C, uniform luminance layer 20, and first diffusion layer 30C. That is, it is possible to determine the positions in the three-axis directions of the X direction, the Y direction, and the Z-axis direction in the XYZ three-axis orthogonal coordinate system. It is thus possible to eliminate positional deviation in the three-axis directions for second diffusion layer 40C, uniform luminance layer 20, first diffusion layer 30C, and the plurality of light-emitting elements 12, thereby preventing the occurrence of the luminance unevenness due to the positional deviation.

Moreover, in the present modification, since first diffusion layer 30C and second diffusion layer 40C are made of the same transparent resin material, there is no refractive index difference on the boundary surfaces in fitting portions between recesses 30a and protrusions 30b of first diffusion layer 30C and between recess 40a and protrusion 40b of second diffusion layer 40C. Thereby, it is possible to prevent the occurrence of shadows due to the fitting portions between recesses 30a and protrusions 30b of first diffusion layer 30C and between recess 40a and protrusion 40b of second diffusion layer 40C.

In lighting device 1C according to the present modification, reflective layer 50 has recess 50a into which protrusion 30b of first diffusion layer 30C is fitted. Recess 50a of reflective layer 50 and protrusion 30b of first diffusion layer 30C can be fitted together by press-fitting. Recess 50a is a through-hole as an example, but is not limited to this and may be a bottomed hole.

In this manner, first diffusion layer 30C and reflective layer 50 can be fixed by fitting protrusions 30b of first diffusion layer 30C into recesses 50a of reflective layer 50. Hence it is possible to determine the positions in the three-axis directions of the X direction, the Y direction, and the Z-axis direction for second diffusion layer 40C, uniform luminance layer 20, first diffusion layer 30C, and reflective layer 50.

### Modification 4 of the First Exemplary Embodiment

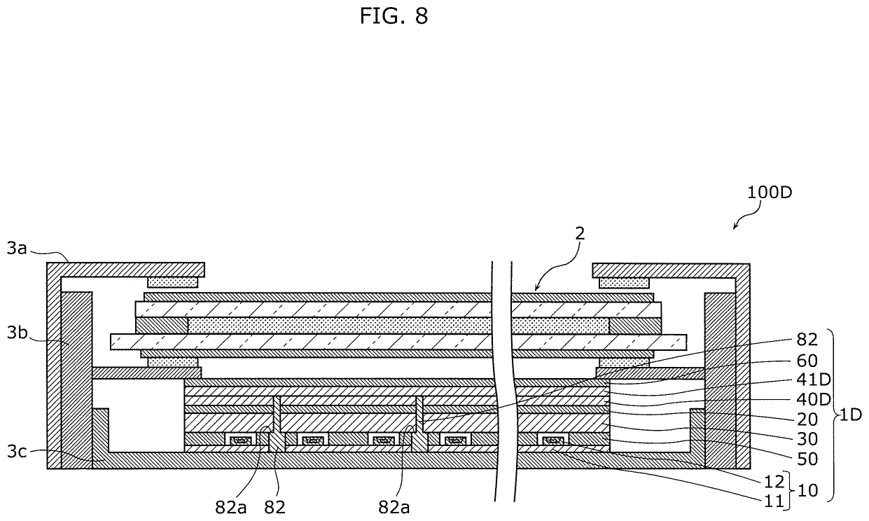

Next, lighting device 1D and liquid crystal display device 100D according to Modification 4 of the first exemplary embodiment will be described with reference to FIG. 8. FIG. 8 is a sectional view schematically illustrating a configuration of liquid crystal display device 100D according to Modification 4 of the first exemplary embodiment.

Lighting device 1D in the present modification differs from the above lighting devices 1A to 1C illustrated in FIGS. 5 to 7 in a method for fixing second diffusion layer 40D, uniform luminance layer 20, first diffusion layer 30, and reflective layer 50.

As illustrated in FIG. 8, in lighting device 1D according to the present modification, second diffusion layer 40D, uniform luminance layer 20, first diffusion layer 30, and reflective layer 50 are fixed by caulking pins 82. A plurality of caulking pins 82 are provided on third frame 3c. As an example, caulking pin 82 is a stainless steel (SUS)-based extra-fine caulking pin.

Caulking pin 82 is inserted through first diffusion layer 30, uniform luminance layer 20, second diffusion layer 40D, reflective layer 50, and substrate 11. Specifically, a through-hole is provided in first diffusion layer 30, uniform luminance layer 20, second diffusion layer 40D, reflective layer 50, and substrate 11, and caulking pins 82 provided in third frame 3c is inserted sequentially through first diffusion layer 30, uniform luminance layer 20, second diffusion layer 40B, reflective layer 50, and substrate 11, so that first diffusion layer 30, uniform luminance layer 20, second diffusion layer 40D, reflective layer 50, and substrate 11 can be fixed.

With this configuration, it is possible to fix horizontal and thickness positions of second diffusion layer 40D, uniform luminance layer 20, first diffusion layer 30, reflective layer 50, and substrate 11. This can eliminate positional deviation in the three-axis directions for second diffusion layer 40D, uniform luminance layer 20, first diffusion layer 30, the reflective layer 50, substrate 11, and the plurality of light-emitting elements 12, thereby preventing the occurrence of the luminance unevenness due to the positional deviation.

Further, in lighting device 1D according to the present modification, second diffusion layer 40 in the first exemplary embodiment is divided into a plurality of parts as in Modification 1 of the first exemplary embodiment. Specifically, in the present modification, second diffusion layer 40 in the first exemplary embodiment is divided into second diffusion layer 40D and third diffusion layer 41D. Lighting device 1D in the present modification includes third diffusion layer 41D disposed on the opposite side of second diffusion layer 40D from the uniform luminance layer 20 side. Specifically, third diffusion layer 41D is laminated with second diffusion layer 40D. In the present modification, caulking pin 82 penetrates second diffusion layer 40D and does not penetrate third diffusion layer 41D.

With this configuration, it is possible to prevent the occurrence of the luminance unevenness due to a tip of caulking pin 82 being shaded. When the tip of the crimp pin 82 protrudes from third diffusion layer 41D, the tip of the crimp pin 82 and optical sheet 60 may interfere with each other, but the interference between the tip of the crimp pin 82 and optical sheet 60 can be avoided by not causing the tip of caulking pin 82 to penetrate third diffusion layer 41D.

In the present modification, caulking pin 82 is a stepped pin having stepped portion 82a, and first diffusion layer 30 is supported by stepped portion 82a of caulking pin 82.

With this configuration, first diffusion layer 30 on which uniform luminance layer 20 is laminated is supported by stepped portion 82a, so that luminance unevenness caused by warpage of uniform luminance layer 20 can be prevented.

### Second Exemplary Embodiment

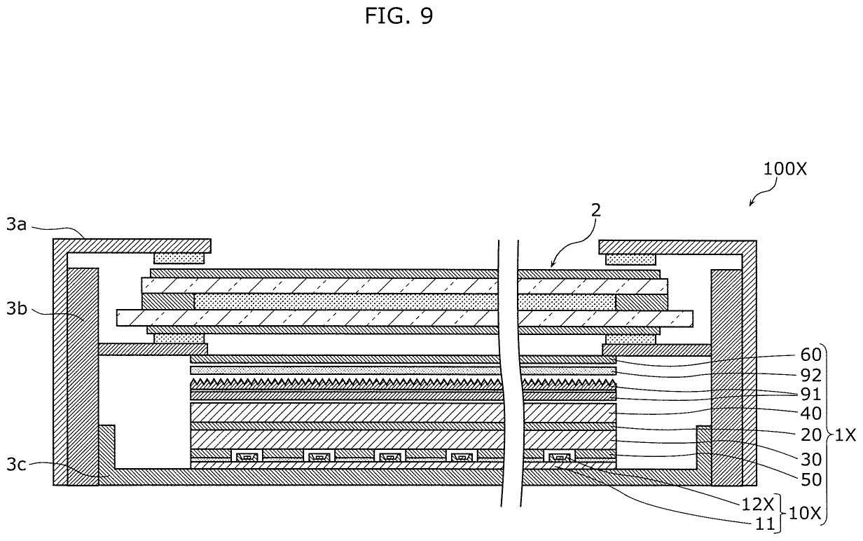

Next, lighting device 1X and liquid crystal display device 100X according to a second exemplary embodiment will be described with reference to FIG. 9. FIG. 9 is a sectional view schematically illustrating a configuration of liquid crystal display device 100X according to the second exemplary embodiment.

Lighting device 1X used in liquid crystal display device 100X according to the present exemplary embodiment further includes prism sheet 91 and wavelength conversion layer 92 in lighting device 1 according to the first exemplary embodiment.

In lighting device 1 according to the first exemplary embodiment, light-emitting element 12 of light source module 10 is a B-Y type white LED light source including a blue LED chip and a yellow phosphor. However, in lighting device 1 according to the present exemplary embodiment, light-emitting element 12X of light source module 10X does not include a yellow phosphor, and light-emitting element 12X has a configuration in which the yellow phosphor is excluded from light-emitting element 12 in the above exemplary embodiment. Accordingly, light-emitting element 12X is a blue LED light source that emits only blue light emitted from the blue LED chip.

Prism sheet 91 is, for example, an orthogonal prism sheet. In this case, prism sheet 91 is made up of two prism sheets disposed such that the directions of the prisms are orthogonal to each other. Prism sheet 91 is made of a transparent resin material such as polycarbonate or acrylic.

Prism sheet 91 is disposed on the opposite side of second diffusion layer 40 from the uniform luminance layer 20 side. In the present exemplary embodiment, prism sheet 91 is disposed between second diffusion layer 40 and optical sheet 60. Specifically, prism sheet 91 is disposed between second diffusion layer 40 and wavelength conversion layer 92.

Wavelength conversion layer 92 converts a wavelength of incident light. In the present exemplary embodiment, wavelength conversion layer 92 converts a wavelength of light emitted from each of the plurality of light-emitting elements 12X. Specifically, wavelength conversion layer 92 emits white light by blue light emitted from each of the plurality of light-emitting elements 12X.

Wavelength conversion layer 92 is, for example, a fluorescent sheet in which a phosphor is dispersed in a translucent substrate. As the light-transmitting substrate of wavelength conversion layer 92, a resin substrate (base resin) made of a light-transmitting resin material such as epoxy, polycarbonate, acrylic, or polyester can be used. These resin materials become phosphor binder resins. As the phosphor of wavelength conversion layer 92, for example, a red phosphor and a green phosphor can be used. In this case, wavelength conversion layer 92 is a fluorescent sheet in which a red phosphor and a green phosphor are dispersed in a translucent substrate. Wavelength conversion layer 92 may be a fluorescent sheet in which a yellow phosphor is dispersed in a translucent substrate. Further, the phosphor of wavelength conversion layer 92 may be a quantum dot phosphor.

Wavelength conversion layer 92 configured in this manner is disposed on the opposite side of second diffusion layer 40 from the uniform luminance layer 20 side. In the present exemplary embodiment, wavelength conversion layer 92 is disposed between second diffusion layer 40 and optical sheet 60. Specifically, wavelength conversion layer 92 is disposed between prism sheet 91 and optical sheet 60. That is, second diffusion layer 40, prism sheet 91, wavelength conversion layer 92, and optical sheet 60 are laminated in this order.

As described above, in lighting device 1X and liquid crystal display device 100X according to the present exemplary embodiment, first diffusion layer 30 is disposed between light source module 10X and uniform luminance layer 20 as in lighting device 1 and liquid crystal display device 100 according to the first exemplary embodiment.

With this configuration, even when the light emitted from each of the plurality of light-emitting elements 12X is blue light with high straightness emitted from the blue LED chip, the light emitted from light-emitting elements 12X can be blurred by first diffusion layer 30 and made incident on uniform luminance layer 20. Thereby, even when the relative positions of the plurality of light-emitting elements 12X and uniform luminance layer 20 slightly deviate from the design conditions, it is possible to prevent the occurrence of the luminance unevenness and maintain the effect of luminance uniform layer 20 making the luminance uniform.

In the present exemplary embodiment, since the blue light transmitted through uniform luminance layer 20 is incident on prism sheet 91 and wavelength conversion layer 92, it is possible to improve the luminance unevenness with the prism sheet 91 while improving the transmittance (luminance efficiency).

### Modification of Second Exemplary Embodiment

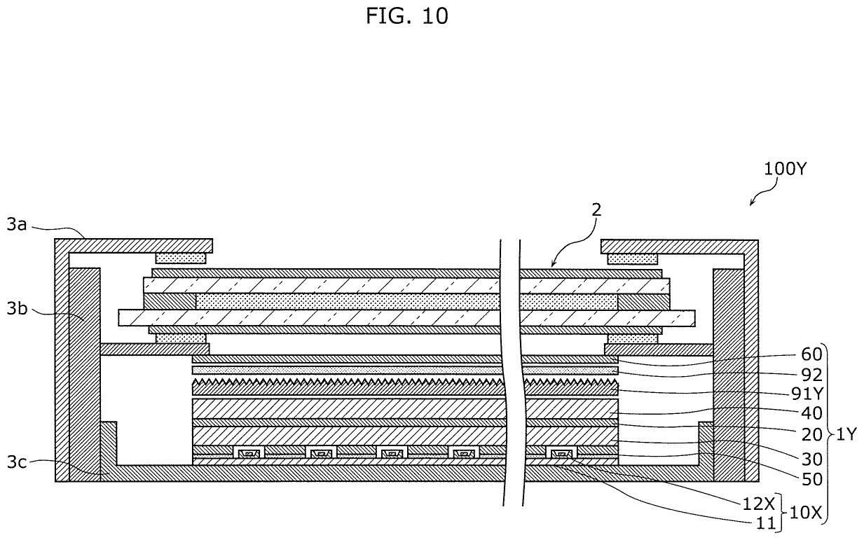

Next, lighting device 1Y and crystal display device 100Y according to a modification of the second exemplary embodiment will be described with reference to FIG. 10. FIG. 10 is a sectional view schematically illustrating a configuration of liquid crystal display device 100Y according to the modification of the second exemplary embodiment.

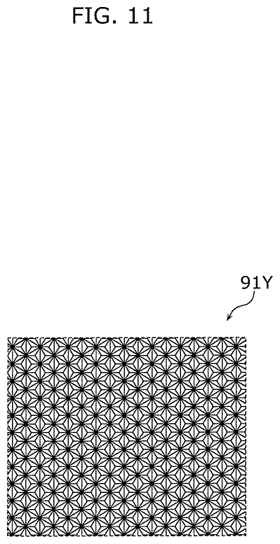

Lighting device 1Y used in liquid crystal display device 100Y according to the present modification differs from lighting device 1X according to the second exemplary embodiment illustrated in FIG. 9 in the configuration of the prism sheet. Specifically, prism sheet 91Y used in lighting device 1Y according to the present modification has a configuration in which a polyhedron structure is provided on a transparent plate such as an acrylic resin. Specifically, prism sheet 91Y has a 100° polyhedron structure as illustrated in FIG. 11.

As described above, according to lighting device 1Y and liquid crystal display device 100Y according to the present modification, the same effects as those of lighting device 1X and liquid crystal display device 100X according to the second exemplary embodiment can be obtained. That is, even when the relative positions of the plurality of light-emitting elements 12X and uniform luminance layer 20 slightly deviate from the design conditions, it is possible to prevent the occurrence of the luminance unevenness and maintain the effect of luminance uniform layer 20 making the luminance uniform.

In the present modification, prism sheet 91Y having the polyhedron structure has been used, but the present disclosure is not limited to this. For example, the polyhedron structure may be formed on a surface of second diffusion layer 40 by hot stamping without using prism sheet 91.

### Modification

As described above, the lighting device and the liquid crystal display device according to the present disclosure have been described based on the exemplary embodiments, but the present disclosure is not limited to the above exemplary embodiments.

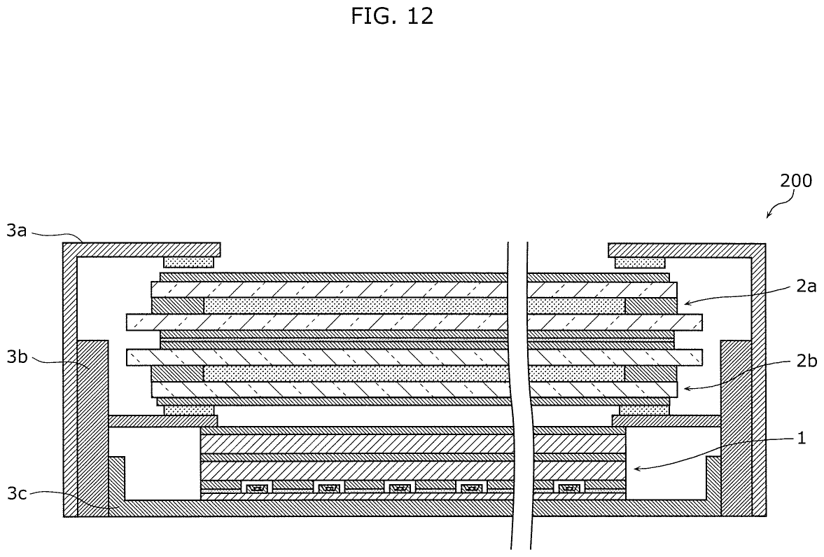

For example, in the first and second exemplary embodiments and the modifications of those exemplary embodiments, the number of liquid crystal display panel 2 has been one, but the present disclosure is not limited to this. That is, a plurality of liquid crystal display panels may be used. Specifically, as in liquid crystal display device 200 illustrated in FIG. 12, first liquid crystal display panel 2a and second liquid crystal display panel 2b may be superposed. In this case, a color image is displayed on first liquid crystal display panel 2a disposed at a position near the observer, and on second liquid crystal display panel 2b disposed on a back surface of first liquid crystal display panel 2a, a monochrome image corresponding to the color image displayed on first liquid crystal display panel 2a may be displayed in synchronization with the color image. Thereby, black can be tightened, so that liquid crystal display device 200 that displays a high-contrast image can be achieved.

In a liquid crystal display device having a plurality of liquid crystal display panels, it is difficult to cool the plurality of liquid crystal display panels. However, in lighting device 1 used in liquid crystal display device 200 according to the present modification, as described above, light source module 10, reflective layer 50, first diffusion layer 30, uniform luminance layer 20, and second diffusion layer 40 are laminated with no air layer interposed between each of the module and layers, so that first liquid crystal display panel 2a and second liquid crystal display panel 2b can be effectively cooled by cooling lighting device 1.

In the second exemplary embodiment, light-emitting element 12X has been configured of the blue LED chip that emits blue light, the present disclosure is not limited to this. For example, light-emitting element 12X may be configured of an LED chip that emits UV light.

Further, in the first and second exemplary embodiments and the modifications of those exemplary embodiments, the case where the lighting device is used as the backlight of the liquid crystal display device has been illustrated, but the present disclosure is not limited to this. The lighting device can be applied to various devices or systems other than the liquid crystal display device. For example, the lighting device can be applied to a lighting fixture such as a ceiling light or a downlight.

Those skilled in the art will readily appreciate that many modifications are possible in the above exemplary embodiment and variations without materially departing from the novel teachings and advantages of the present disclosure. Accordingly, all such modifications are intended to be included within the scope of the present disclosure.

What is claimed is:

1. A lighting device comprising:
a light source module having a plurality of light-emitting elements arranged two-dimensionally;
a uniform luminance layer disposed on a light emission side of the light source module; and
a first diffusion layer disposed between the light source module and the uniform luminance layer,
wherein the uniform luminance layer has a higher light transmittance as a distance from a point intersecting with an optical axis of each of the plurality of light-emitting elements increases.

2. The lighting device according to claim 1, further comprising a reflective layer disposed on a light source module side of the uniform luminance layer and having a reflective surface that reflects light emitted from the plurality of light-emitting elements,
wherein
the uniform luminance layer has light reflectivity at least on a surface on the light source module side,
the uniform luminance layer is provided with a plurality of pores where light emitted from the plurality of light-emitting elements passes respectively, and
the plurality of pores are configured to increase the light transmittance as the distance from the point intersecting with the optical axis of the plurality of light-emitting elements increases.

3. The lighting device according to claim 2, wherein
the reflective surface of the reflective layer is located closer to the uniform luminance layer than light-emitting surfaces of the plurality of light-emitting elements, and
the first diffusion layer is supported by the reflective layer.

4. The lighting device according to claim 2, further comprising a second diffusion layer disposed on an opposite side of the uniform luminance layer from the first diffusion layer side.

5. The lighting device according to claim 4, wherein
the reflective layer and the first diffusion layer are bonded with a first adhesive layer,
the first diffusion layer and the uniform luminance layer are bonded with a second adhesive layer, and
the uniform luminance layer and the second diffusion layer are bonded with a third adhesive layer.

6. The lighting device according to claim 4, further comprising a base that supports the light source module,
wherein
the reflective layer is disposed between the base and the first diffusion layer, and
the second diffusion layer, the uniform luminance layer, the first diffusion layer, the reflective layer, and the base are fixed with a transparent rivet pin that penetrates the second diffusion layer, the uniform luminance layer, the first diffusion layer, the reflective layer, and the base.

7. The lighting device according to claim 6, further comprising a third diffusion layer disposed on an opposite side of the second diffusion layer from the uniform luminance layer side,
wherein
a recess for storing a pinhead of the transparent rivet pin is provided on a surface of the second diffusion layer on the third diffusion layer side, and
the transparent rivet pin penetrates the second diffusion layer and does not penetrate the third diffusion layer.

8. The lighting device according to claim 4, wherein
the second diffusion layer has a protrusion provided on a surface facing the uniform luminance layer side,
the first diffusion layer has a recess provided at a position facing the protrusion of the second diffusion layer on the surface facing the uniform luminance layer side,
the uniform luminance layer has a through-hole where the protrusion of the second diffusion layer penetrates, and
the protrusion of the second diffusion layer penetrates the through-hole of the uniform luminance layer and is fitted in the recess of the first diffusion layer.

9. The lighting device according to claim 8, wherein
the first diffusion layer has a protrusion provided at a position facing the recess on the surface facing the uniform luminance layer side, and
the reflective layer has a recess fitted with the protrusion of the first diffusion layer.

10. The lighting device according to claim 4, further comprising:
a base that supports the light source module; and
a caulking pin provided on the base,
wherein the caulking pin is inserted through the first diffusion layer, the uniform luminance layer, and the second diffusion layer.

11. The lighting device according to claim 10, further comprising a third diffusion layer disposed on an opposite side of the second diffusion layer from the uniform luminance layer side,
wherein the caulking pin penetrates the second diffusion layer and does not penetrate the third diffusion layer.

12. The lighting device according to claim 10, wherein
the caulking pin is a stepped pin having a stepped portion, and
the first diffusion layer is supported by the stepped portion.

13. The lighting device according to claim 1, wherein each of the plurality of light-emitting elements emits white light.

14. The lighting device according to claim 1, further comprising a wavelength conversion layer that converts a wavelength of light emitted from each of the plurality of light-emitting elements,
wherein the wavelength conversion layer is disposed on an opposite side of the second diffusion layer from the uniform luminance layer side.

15. The lighting device according to claim 14, further comprising a prism sheet disposed between the second diffusion layer and the wavelength conversion layer.

16. The lighting device according to claim 14, wherein the wavelength conversion layer emits white light.

17. A liquid crystal display apparatus comprising:
the lighting device according to claim 1; and
a liquid crystal display panel disposed on a light emission side of the lighting device.
